(19) United States
(12) Patent Application Publication
(10) Pub. No.: US 2015/0158680 A1
(43) Pub. Date: Jun. 11, 2015

(54) Pot Tipper

(71) Applicant: Asa Conant, Rydal, GA (US)

(72) Inventor: Asa Conant, Rydal, GA (US)

(21) Appl. No.: 14/563,916

(22) Filed: Dec. 8, 2014

Related U.S. Application Data
(60) Provisional application No. 61/912,595, filed on Dec. 6, 2013.

(51) Int. Cl. B65G 65/23; A47J 27/00

(52) U.S. Cl. CPC B65G 65/23; A47J 27/00

(57) ABSTRACT

Implementations of a pot tipper for holding and tipping a container are provided. In some implementations, the pot tipper comprises a fixture for holding and tipping the container and a folding stand to support the fixture. In some implementations, the fixture comprises a body portion having an opening configured to receive and secure a pot, bowl, and/or similar container therein, two pivot portions on opposite sides of the fixture, and handle portions. In some implementations, the folding stand comprises two arms on opposite sides of the stand and a base. In some implementations, the two pivot portions of the fixture are configured to fit within a holder portion located at the distal end of each arm of the folding stand.

### CROSS REFERENCE TO RELATED APPLICATION

This application claims the benefit of U.S. patent application Ser. No. 61/912,595, which was filed on Dec. 6, 2013, and is incorporated herein by reference in its entirety.

### TECHNICAL FIELD

This disclosure relates to implementations of a pot tipper.

### BACKGROUND

A pot or bowl is a common container used for cooking, baking, or storage. Pots or bowls also are used for combining and mixing various ingredients prior to their transfer to another container for heating or serving. Pouring out the contents of a pot or bowl requires a user to position the rim of the pot over the receiving container and pour. However, this task may be challenging for a number of reasons. First, due to disability, some people may be unable to pour out the contents of a pot. Second, some may miss the receiving container and spill the contents of the pot thereby creating a mess. Third, due to weight or size, some pots may be unwieldy and require two people to properly tip and pour the contents out.

### BRIEF DESCRIPTION OF THE DRAWINGS

FIGS. 1, 2A-2B, and 3A-3B illustrate an example pot tipper according to the present disclosure.

FIGS. 4A-4B and 5A-5B illustrate another implementation of a pot tipper according to the present disclosure.

FIG. 6 illustrates an alternate method of using the pot tipper illustrated in FIGS. 1, 2A-2B, and 3A-3B.

FIG. 7 illustrates an alternate method of using the pot tipper illustrated in FIGS. 4A-4B and 5A-5B.

### DETAILED DESCRIPTION

Implementations of a pot tipper for holding and tipping a container are provided. In some implementations, the pot tipper comprises a fixture for holding and tipping the container and a folding stand to support the fixture. In some implementations, the fixture comprises a body portion having an opening configured to receive and secure a pot, bowl, and/or similar container therein, two pivot portions on opposite sides of the fixture, and handle portions. In some implementations, the folding stand comprises two arms on opposite sides of the stand and a base. In some implementations, the two pivot portions of the fixture are configured to fit within a holder portion located at the distal end of each arm of the folding stand. In some implementations, the two arms may be secured by hinges to the base of the folding stand. In some implementations, each of the two arms may have a cutout therein. In some implementations, the cutouts in conjunction with the hinges may allow the arms to fold down compactly together. This may allow for easier storage of the pot tipper when not in use.

In another example implementation, the folding stand of the pot tipper is configured so that it may be mounted on a surface (such as the underside of a cabinet) with the arms extending downwardly to hold the fixture or the handles of a pot. When the folding stand is mounted on a surface (such as the underside of a cabinet), the arms can be folded upwardly when not in use and a separate storage place for the stand may not be needed.

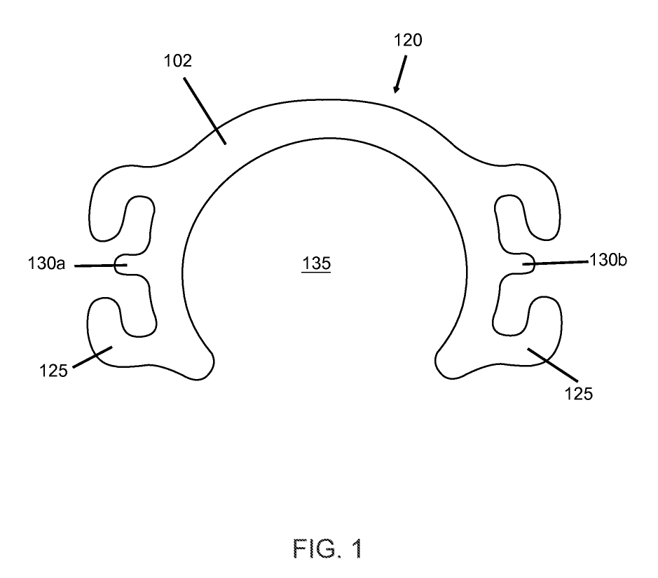

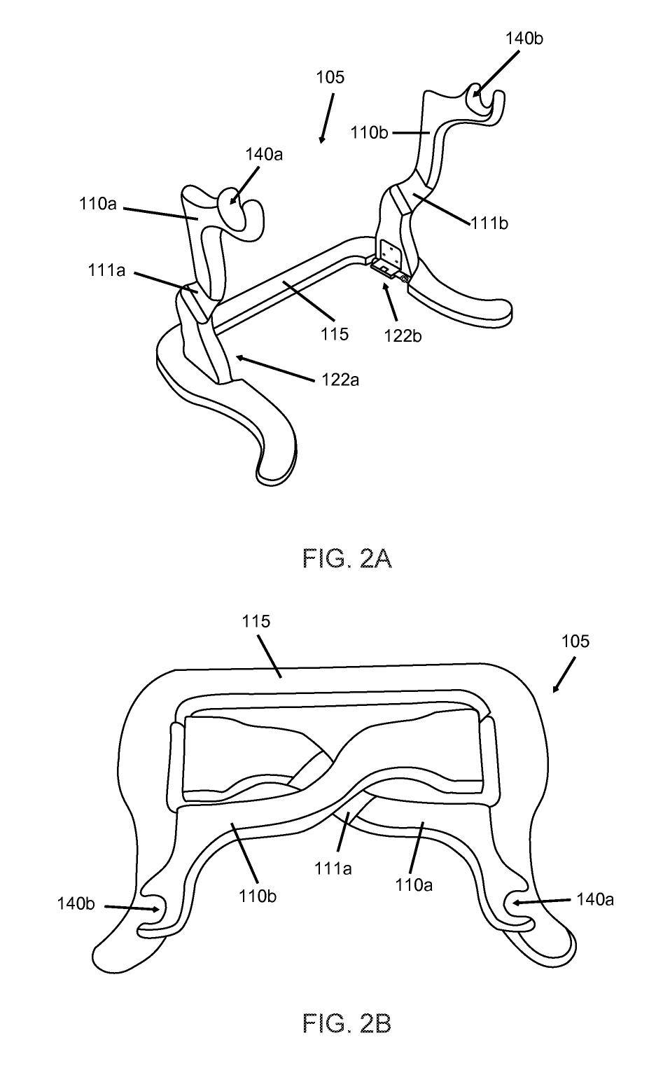

FIGS. 1-3B illustrate an example pot tipper 100 for holding and tipping a container 180 according to the present disclosure. As shown in FIGS. 1-3B, in some implementations, the pot tipper 100 comprises a fixture 120 (see, e.g., FIG. 1) for holding and tipping the container 180 and a folding stand 105 (see, e.g., FIGS. 2A-2B) to support the fixture 120.

As shown in FIG. 1, the fixture 120 comprises a body portion 102 having an opening 135 configured to receive and secure a pot, bowl, and/or similar container therein, two pivot portions 130a, b (collectively 130) on opposite sides of the fixture 120, and handle portions 125.

As shown in FIG. 1, in some implementations, the opening 135 can be generally U-shaped. In some implementations, the opening 135 can be any shape suitable for receiving a desired container therein.

As shown in FIG. 1, in some implementations, the fixture 120 may have handle portions 125 on opposite sides of the fixture 120 that may be grasped. The handle portions 125 may be any portion(s) of the body portion 102 suitable for grasping the fixture for tipping a container secured within the opening 135 of the fixture 120 as will be described below. In some implementations, the handle portions 125 may be decorative as shown in FIG. 1 or any other shape or configuration suitable for grasping the fixture 120 for tipping a container secured within the opening of the fixture as will be described below.

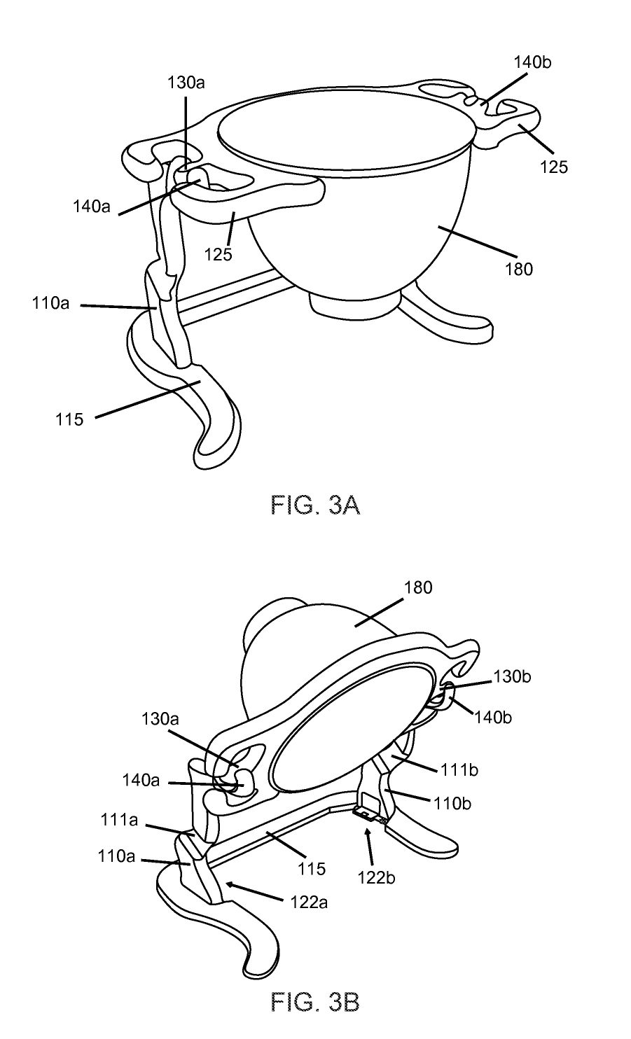

In some implementations, the two pivot portions 130 define a pivot point for the fixture 120. In some implementations, the two pivot portions 130 are configured to fit within the holder portions 140 of the folding stand 105 (see, e.g., FIGS. 2A and 3A). In some implementations, the pivot portions 130 may be any suitable shape to allow the fixture 120 to rotate when it is placed on the folding stand 105 and pressure is exerted on the handle portions 125.

As shown in FIG. 2A, in some implementations, the folding stand 105 comprises two arms 110a, b (collectively 110) on opposite sides of the stand 105 and a base 115.

In some implementations, the arms 110a, b include holder portions 140a, b, respectively, at distal ends of the arms configured to hold the fixture 120. In some implementations, the holder portion 140a, b of each arm 110a, b, respectively, may be configured to receive and hold the pivot portions 130 of the fixture 120. In some implementations, the holder portions 140a, b are generally U-shaped. In some implementations, the holder portions 140 are any suitable shape to receive and hold the pivot portions 130 of the fixture 120 and allow the fixture 120 to rotate when pressure is exerted on the handle portions 125.

In some implementations, the two arms 110a, b may be secured by hinges 122a (not shown), b to the base 115 of the folding stand 105. In some implementations, each of the two arms 110a, b may have a cutout 111a, b, respectively, therein. The cutout 111a of the first arm 110a is configured to receive a portion of the second arm 110b therein and the cutout 111b of the second arm 110b is configured to receive a portion of the first arm 110a therein. As shown in FIG. 2B, the cutouts 111a, b in conjunction with the hinges 122a, b may allow the arms 110 to fold down compactly together. This may allow for easier storage of the pot tipper 100 when not in use.

In some implementations, the fixture 120, arms 110, and/or base 115 may be made from wood. In some implementations, the fixture 120, arms 110, and/or base 115 may be manufactured from any suitable material.

To assemble the pot tipper 100, the folding stand 105 may be placed on a horizontal surface and the two arms 110a, b may be rotated into an upright position (see FIG. 2A). The fixture 120 may then be oriented over the folding stand 105 so that the pivot portions 130a, b may be received within the holder portions 140a, b, respectively, of the arms 110 when the fixture 120 is lowered into place (see, e.g., FIG. 3A). A pot, bowl, or similar container, may then be secured within the opening 135 of the fixture (see, e.g., FIG. 3A).

To use the pot tipper 100 to pour out the contents of a pot, bowl, or similar container into a receiving container, a receiving container may be first placed under the fixture 120. Then, a handle portion of the fixture 120 may be grasped and used to rotate the fixture 120, thereby tipping the pot and pouring out its contents or a portion thereof (see, e.g., FIG. 3B).

In an alternative embodiment, the fixture 120 may be placed over a sink. Then a first handle of a pot is placed on the first pivot portion and a second handle of the pot is placed on a second pivot portion. The pot is then grasped and rotated to pour out the content or a portion thereof into the sink.

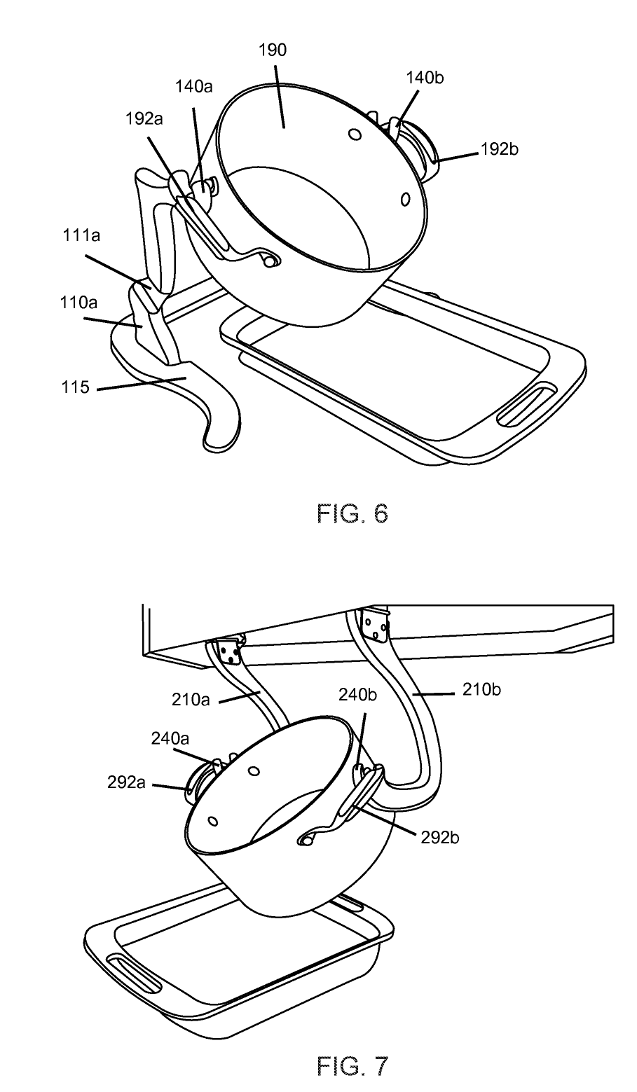

As shown in FIG. 6, in some implementations, the folding stand 105 may be used to hold a container (e.g., a pot) without the fixture 120. For example, a pot 190 may be oriented over the folding stand 105 so that the handles 192a, b of the pot may be received within the holder portions 140a, b, respectively, of the arms 110 when the pot 190 is lowered into place. Then, the handles 192 (or any other suitable portion) of the pot 190 may be grasped and used to rotate the pot 190, thereby tipping the pot and pouring out its contents or a portion thereof.

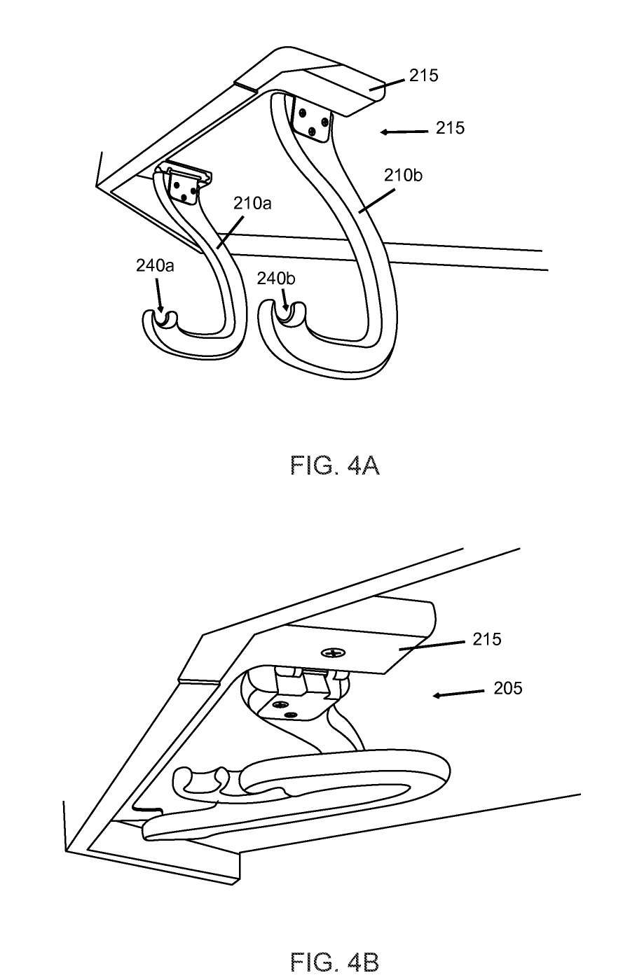

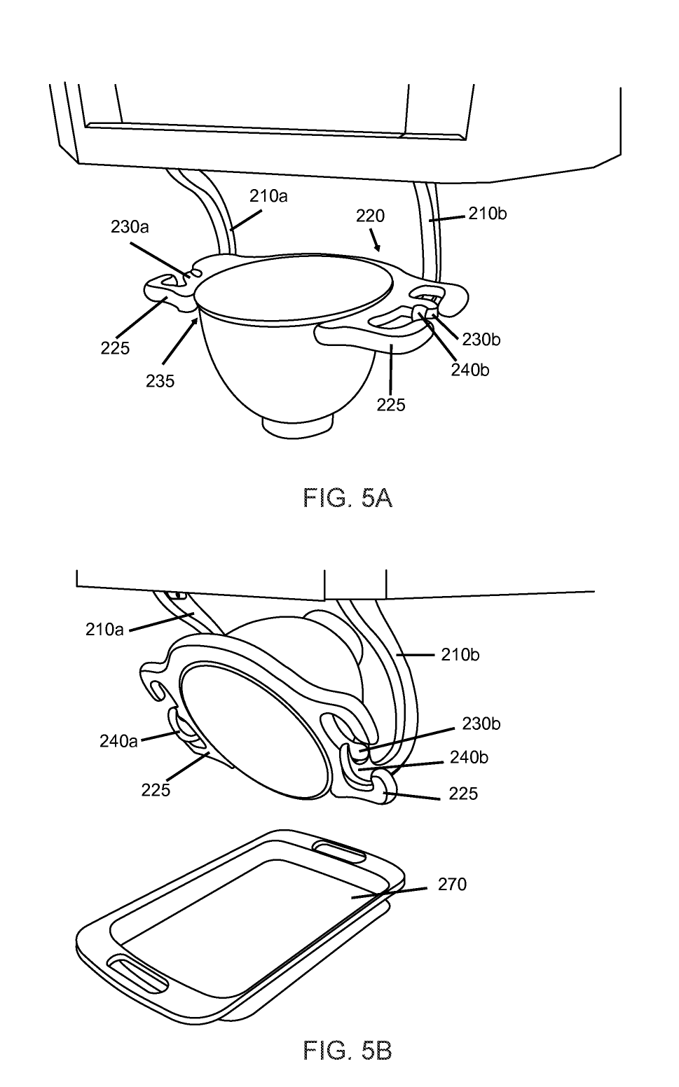

FIGS. 4A-5B illustrate another implementation of a pot tipper 200 according to the present disclosure. The pot tipper 200 comprises a folding stand 205 (see, e.g., FIG. 4A and 4B) and a fixture 220 (see, e.g., FIG. 5A).

In some implementations, the fixture 220 can be the same as fixture 120.

As shown in FIG. 2A, in some implementations, the folding stand 205 comprises two arms 210a, b (collectively 210) on opposite sides of the stand 205 and a base 215.

In some implementations, each arm 210a, b includes a holder portion 240a, b, respectively, at a distal end thereof configured to hold the fixture 220. In some implementations, the holder portion 240a, b of each arm 210a, b, respectively, may be configured to receive and hold the pivot portions 230a, b (collectively 230) of the fixture 220. In some implementations, the holder portions 240a, b are generally U-shaped. In some implementations, the holder portions 240 are any suitable shape to receive and hold the pivot portions 230 of the fixture 220 and allow the fixture 220 to rotate when pressure is exerted on the handle portions 225.

In some implementations, the folding stand 205 is similar to the folding stand 105 except that the arms 210a, b, are configured such that the folding stand 205 may be mounted on a surface (such as the underside of a cabinet) with the arms extending downwardly to hold the fixture 220 or the handles of a pot. When the folding stand 205 is mounted on a surface, the arms can be folded upwardly when not in use and a separate storage place for the stand 205 may not be needed.

To assemble the pot tipper 200, the folding stand 205 may be mounted on a surface and the two arms 110a, b may be rotated into a downward position (see FIG. 4B). The fixture 220 may then be oriented over the holder portions 240 of the folding stand 205 so that the pivots portions 230a, b may be received within the holder portions 240a, b, respectively, of the arms 210 when the fixture 220 is lowered into place (see, e.g., FIG. 5A). A pot, bowl, or similar container, may then be secured within the opening 235 of the fixture (see, e.g., FIG. 5A).

To use the pot tipper 200 to pour out the contents of a pot, bowl, or similar container into a receiving container, a receiving container 270 may be first placed under the fixture 220 (see, e.g., FIG. 5B). Then, a handle portion 225 of the fixture 220 may be grasped and used to rotate the fixture 220, thereby tipping the pot and pouring out its contents or a portion thereof (see, e.g., FIG. 5B).

When finished with the pot tipper 200, the arms 210a, b may be folded upwardly for storage.

As shown in FIG. 7, in some implementations, the folding stand 215 may be used to hold a container (e.g., a pot) without the fixture 220. For example, a pot 290 may be oriented over the holder portions 240 of the folding stand 205 so that the handles 292a, b (collectively 292) of the pot 290 may be received within the holder portions 240a, b, respectively, of the arms 210 when the pot 290 is lowered into place. Then, the handles 292 (or any other suitable portion) of the pot 290 may be grasped and used to rotate the pot 290, thereby tipping the pot and pouring out its contents or portion thereof.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A pot tipper comprising:
a stand comprising base having a first arm and second arm attached thereto wherein the first arm has a first holder portion at a distal end thereof and the second arm has a second holder portion at a distal end thereof, wherein the first arm and the second arm are on opposite sides of the base; and
a fixture comprising a body portion having an opening configured to receive a container therein, a first pivot portion and a second pivot portion, and at least a first handle portion;
wherein the first holder portion of the first arm is configured to receive the first pivot portion therein and the second holder portion of the second arm is configured to receive the second pivot portion therein.

2. The pot tipper of claim 1 wherein the first arm and second arm are each secured to the base by a hinge.

3. The pot tipper of claim 2 wherein the first arm and the second arm each have a cutout thereon, the cutout of the first arm is configured to receive a portion of the second arm therein and the cutout of the second arm is configured to receive a portion of the first arm therein.

4. A method of using the pot tipper of claim 1, the method comprising:
placing the first pivot portion into the first holder portion of the first arm and the second pivot portion into the second holder portion of the second arm;
securing a container within the opening of the fixture; and
applying force to the at least one handle portion to rotate the fixture.

5. The method of claim 4 wherein the first arm and second arm are each secured to the base by a hinge, the method further comprises:
placing the base onto a horizontal surface; and
rotating the first arm and the second arm into an upright position.

6. The method of claim 4 wherein the first arm and second arm are each secured to the base by a hinge, the method further comprises:
securing the base to an underside of a cabinet; and
rotating the first arm and the second arm into a downward position.

7. The method of claim 4 further comprises:
placing a receiving container under the fixture,
wherein applying force to the at least one handle portion to rotate the fixture comprises applying force to the at least one handle portion to rotate the fixture to pour out at least a portion of the contents of the container into the receiving container.

8. A pot tipper comprising:
a stand comprising a base having a first arm and second arm each secured by a hinge thereto wherein the first arm has a first holder portion at a distal end thereof and the second arm has a second holder portion at a distal end thereof, wherein the first arm and the second arm are on opposite sides of the base.

9. The pot tipper of claim 8 wherein the first arm and the second arm each have a cutout thereon, the cutout of the first arm is configured to receive a portion of the second arm therein and the cutout of the second arm is configured to receive a portion of the first arm therein.
